(19) United States
(12) Patent Application Publication
(10) Pub. No.: US 2010/0217984 A1
(43) Pub. Date: Aug. 26, 2010

(54) METHODS AND APPARATUS FOR ENCRYPTING AND DECRYPTING EMAIL MESSAGES

(76) Inventor: Gregory G. Hill, Schwenksville, PA (US)

Correspondence Address: K&L Gates LLP, P.O. Box 1135, CHICAGO, IL, 60690, US

(21) Appl. No.: 12/706,548

(22) Filed: Feb. 16, 2010

Related U.S. Application Data
(60) Provisional application No. 61/152,433, filed on Feb. 13, 2009.

(51) Int. Cl. H04L 9/32; G06F 15/16

(52) U.S. Cl. 713/168; 709/206

(57) ABSTRACT

An e-mail encryption method the sender embeds commands and optionally, parameters relating to the commands in an e-mail message. A domain suffix associated with an encryption e-mail server is appended to the recipient e-mail address before sending the e-mail message. The e-mail message is sent and delivered to the encryption e-mail server. The encryption e-mail server parses the e-mail message and executes any commands, optionally executing the commands based on submitted parameters. The encryption e-mail server encrypts the message and forwards the encryption message, or alternatively, a link to a memory location in the encryption email server where the encryption e-mail message is stored. The recipient receives an email notifying them of the encrypted message. The recipient is prompted for a password. The password is validated. If valid and no limits on the e-mail are exceeded, the contents of the encrypted e-mail message are decrypted and displayed for the recipient.

### RELATED APPLICATIONS

The present application claims priority to and the benefit of provisional patent application Ser. No. 61/152,433 entitled “Method of E-mail Encryption and Decryption” filed Feb. 13, 2009 the entire contents of which are hereby incorporated by reference.

### TECHNICAL FIELD

The present application relates in general to encryption and more specifically to methods and apparatus for encrypting and decrypting email messages.

### BACKGROUND

As computers have become commonplace and inter-connectivity provided by public networks such as the Internet has become prevalent, the way that we communicate has changed. Communication through electronic mail (e-mail) has become increasingly popular and is seen by many as a replacement for traditional paper-based methods for communicating by mail. E-mail allows people to communicate through an e-mail client application on a desktop computer or mobile device, or to access a central service through a portal such as a website. A user may access a website through a suitable Internet browser. Upon accessing the e-mail site, the user is identified by specifying an account associated with an e-mail server servicing the e-mail site. The e-mail account may also be password protected, requiring the user to supply a password in addition to identifying the e-mail account to gain access to the contents of the e-mail account contents. Once access is granted to the e-mail account, the user may receive and read messages, reply or forward messages, write and send new messages, or organize and delete messages. Similar functionality is available locally on the user's computer through the use of an e-mail client that communicates with a remote e-mail server and uploads or downloads e-mail messages through the e-mail client. The e-mail client stores the message content on the user's computer where the content may be managed locally by the user. Passwords may be stored on the e-mail clients for convenience, allowing anyone with access to the e-mail client, whether on a computer or other device such as a personal digital assistant (PDA), to read the e-mail.

In traditional postal systems, privacy of communications is insured through sealing an envelope containing the communication so that if tampering occurred, the tampering would be evident to the recipient. Additionally, laws providing punishment for violating the privacy of postal communications further protect the expectation of privacy relating to the communications.

When an electronic communication is received, it may have traveled through a number of servers and routers before reaching its destination e-mail server. These servers may or may not be secure and while en route, the message may be accessible by third parties other than the sender and the recipient. As a result methods have been developed to protect the privacy of electronic communications.

Encryption allows for the transmission of information between a sender and recipient while preserving the privacy of the data contained in the communication. Encryption takes the communication and encrypts the data making up the communication using one or more keys. The sender and the recipient must have access to the keys to be able to encrypt the message before sending and to decrypt the message upon reception. The key used to encrypt the message may be the same or different than the key used to decrypt the message. When the encryption and decryption keys are different, it is referred to as public key encryption. When using public key encryption, the recipient generates a private key. Only the intended recipient has access to the private key. Based on the private key, a public key is generated using a mathematical algorithm that prevents the private key from being derived from the public key. The public key may then be freely distributed to potential message senders. When sending a message to the intended recipient, the message is encrypted using the recipient's public key. Anyone with access to the public key may encrypt a message to the recipient. Only the recipient may decode the message due to the fact that decryption requires the private key to which only the recipient has access.

Secret key encryption, or symmetric cryptography uses the same key to encrypt and decrypt the message. Accordingly, both the sender and the recipient must be in possession of the key to enable communication between the sender and recipient. The means of sharing the password or key must be managed carefully, as anyone with access to the key may decrypt a message intended for the recipient. Secret key encryption is less mathematically complex than public key encryption and may therefore be performed faster than public key encryption methods.

Encryption may occur at a sender's computer through software resident in the user's computer that encrypts communications based on encryption keys that may be stored on the computer or entered by the user at the time of encryption. Encryption may also be performed remotely by creating the communication at a website and encryption being performed by resources controlled by the service provider that owns the website. Encryption programs may be cumbersome to use and may require the management of a significant number of keys. Public key encryption is complex and requires additional time to send an encrypted message. Additionally, once an encrypted message is sent, the user may decrypt the message for an unlimited time period and an unlimited number of times. There may be occasions where a sender may wish to rescind an encrypted message, establish an expiration time period for a message, or limit the number of times the encrypted message may be decrypted.

Accordingly, it would be beneficial to provide a simple encryption method for ensuring the privacy of an electronic communication and to provide control to the sender to restrict the decryption of an encrypted message.

### SUMMARY

An e-mail encryption method is disclosed where the sender embeds commands and optionally, parameters relating to the commands in an e-mail message. A domain suffix associated with an encryption e-mail server is appended to the recipient e-mail address before sending the e-mail message. The e-mail message is sent and delivered to the encryption e-mail server. The encryption e-mail server parses the e-mail message and executes any commands, optionally executing the commands based on submitted parameters. The encryption e-mail server encrypts the message and forwards the encryption message, or alternatively, a link to a memory location in the encryption e-mail server where the encryption e-mail message is stored.

The recipient receives an e-mail notifying them of the encrypted message. The recipient is prompted for a password associated with the e-mail message. The password is validated, conditions are checked such as expiration and/or the number of times the message has been read, and if valid, the contents of the encrypted e-mail message are decrypted and displayed for the recipient.

### BRIEF DESCRIPTION OF THE FIGURES

FIG. 1 shows an example of an electronic mail system that is configured for encryption and decryption of electronic mail messages.

FIG. 2 is an example of a block diagram of a method of creating an electronic mail message for encryption.

FIG. 3 is an example of a block diagram of a method of encrypting a electronic mail message.

FIG. 4 is an example of a block diagram of a method of controlling decryption of an encrypted electronic mail message.

FIG. 5 is an example of a block diagram of a method of decrypting an encrypted electronic mail message.

### DETAILED DESCRIPTION

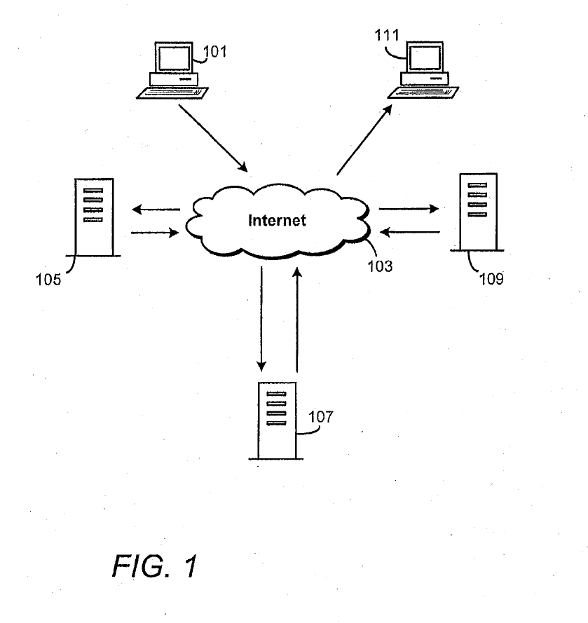

FIG. 1 shows an example of an electronic mail (e-mail) system. A sender of an e-mail enters the message to send at a sender terminal 101. Sender terminal 101 may be a personal computer, a personal digital assistant (PDA), mobile device or any other device capable of sending electronic mail. The sender terminal 101 and the recipient terminal 111 typically include a processor and memory configured to store software, although other configurations may be used. The sender terminal 101 may contain software for managing and creating e-mail such as an e-mail client, E-mail client software within sender terminal 101 may be configured to connect to the sender's e-mail server 105. The e-mail client in sender terminal 101 is coupled to a computer network 103. Additionally, sender's e-mail server 105 is connected to computer network 103. The e-mail client software in the sender terminal communicates with sender's e-mail server 105 through the computer network 103 and sends and/or receives e-mail messages sent by or intended for the sender.

The e-mail clients and servers communicate with each other using Simple Mail Transport Protocol (SMTP). SMTP is an Internet standard that is well known as a method of communicating e-mails between computers. The sending computer, whether client or server, identifies itself to the recipient computer, identifies the sender, and lists the recipients of the e-mail. If the receiving computer agrees to accept the e-mail, the contents are then transferred. The transmission may take place over secure encrypted channels or as plain text. Methods to verify the sender, including but not limited to Sender Policy Framework and DomainKeys may be used.

Sender's e-mail server 105 is associated with an Internet domain. The sender's e-mail server 105 maintains a set of user accounts associated with the Internet domain corresponding to the sender's e-mail server 105. The sender is identified as an authorized user of the sender e-mail server 105 through the user account assigned to the sender. E-mail messages sent by the sender are submitted to the sender's e-mail server 105 which authenticates the message as coming from the sender by authenticating the user with a password that corresponds to the sender's user account. After authentication, the sender e-mail server 105 sends the e-mail by transmitting the e-mail message through the computer network 103.

Included in the sender's e-mail message is the address of the intended recipient(s). While the e-mail message may be sent to any number of recipients, the process is hereinafter described with respect to a single recipient. An identical process occurs for each recipient when there are multiple recipients specified in the e-mail message from the sender. The sender's e-mail message transmitted over the computer network 103 by the sender's e-mail server 105 contains the e-mail address of the intended recipient. The recipient is associated with a user account on the recipient e-mail server 109 and the recipient e-mail server 109 is associated with an Internet domain. While different e-mail servers are shown for the sender and the recipient in FIG. 1, the sender and the recipient may have user accounts on the same e-mail server.

The e-mail message is received by the recipient e-mail server 109 which parses the recipient e-mail address to determine if the name specified as the recipient corresponds to a valid user account on the recipient e-mail server 109 identified by the domain name specified in the recipient e-mail address. If the recipient e-mail address is a valid user account on the recipient e-mail server 109, the message is stored by the recipient e-mail server and linked to the recipient's user account. The message is available to be read when the recipient accesses his/her e-mail account.

Recipient may access his/her e-mail account through a recipient terminal 111. Recipient terminal 111 may be a personal computer, a personal digital assistant (PDA), mobile device or any other device capable of sending electronic mail. The recipient terminal 111 may contain software for managing and creating e-mail such as an e-mail client. E-mail client software within recipient terminal 111 is configured to connect to the recipient e-mail server 109. E-mail client in recipient terminal 111 is coupled to a computer network 103.

Additionally, recipient's e-mail server 109 is connected to computer network 103. The e-mail client software in the recipient terminal 111 communicates with recipient e-mail server 109 through the computer network 103 and receives e-mail messages intended for the recipient.

Recipient e-mail server 109 is associated with an Internet domain. The recipient e-mail server 109 maintains a set of user accounts stored at the Internet domain corresponding to the recipient e-mail server 109. The recipient is associated to a user account assigned to the recipient. E-mail messages sent to the recipient are submitted to the recipient e-mail server 109 which verifies the message is addressed to a known user on the recipient e-mail server 109.

When the recipient accesses their e-mail account, the recipient terminal 111 communicates with the recipient e-mail server 109 through computer network 103. The recipient submits their password to the recipient e-mail server 109 which validates the recipient and allows the recipient to access e-mail messages stored on the recipient e-mail server 109, The recipient may submit their password through software such as an e-mail client or alternatively, a web browser.

The sender of an e-mail message may want to encrypt an e-mail message to protect its contents from being viewed by someone other than the intended recipient. To encrypt an e-mail message, the sender creates a new e-mail message using the sender terminal 101. Sender addresses the email to the intended recipient in a manner known in the art. Sender may enter the recipient address through a stored address book or contact list stored in the sender terminal 101, or the sender may type in the recipient address manually from an appropriate input device coupled to sender terminal 101. The recipient address is formatted with the user account followed by the “at” symbol (@) followed by the Internet domain associated with the recipient e-mail server 109. For example, a recipient e-mail address may be john.doe@recipient.com.

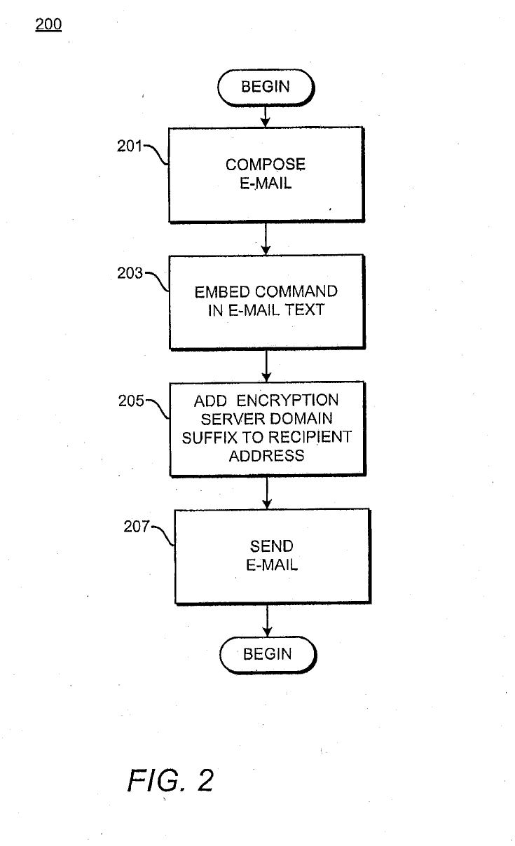

To encrypt a message addressed to john.doe@recipient.com, the sender appends an additional period (.) and Internet domain name to the end of the recipient address. The additional Internet domain is associated with an encryption e-mail server 107. The appending of the encryption e-mail server 107 domain suffix will be explained in greater detail hereinafter with respect to FIG. 2. The sender sends the e-mail containing a recipient address that now contains the complete recipient e-mail address and an additional Internet domain associated with encryption e-mail server 107. The e-mail is routed from sender terminal 101 through the computer network 103 and sender e-mail server 105 to the encryption server 107, which receives the email message and parses the message to encrypt the message in a manner that will described in greater detail hereinafter. Following encryption, the encryption e-mail server 107 removes the Internet domain associated with the encryption server 107 from the e-mail message, leaving the original complete e-mail address of the intended recipient. The e-mail message is transmitted from the encryption server 107 to the computer network 103 which routes the message to the recipient e-mail server 109. The recipient address is verified as a valid user account on the recipient e-mail server 109. If the recipient address is valid, the message is stored on recipient e-mail server 109 associated with the recipient user account. The recipient may access the stored email message through the recipient terminal 101 by accessing the recipient a-mail server 109 through computer network 103.

FIG. 2 is a block diagram of an example method of creating an e-mail for encryption using an encryption e-mail server 107. Preferably, at least a portion of the process is embodied in one or more software programs which is stored in one or more memories and executed by one or more processors. Although the process is described with reference to the flowchart illustrated in FIG. 2, it will be appreciated that many other methods of performing the acts associated with process may be used. For example, the order of many of the steps may be changed, and some of the steps described may be optional and/or performed manually.

When a sender wishes to encrypt an e-mail the sender is sending to a recipient, the sender begins by composing an e-mail message in a conventional manner 201. To indicate to the encryption e-mail server that the e-mail is to be encrypted, or to indicate sender preferences in the manner in which the e-mail is encrypted, the sender may embed a command in the body of the email 203. The command may be identified by a specific character. For example a command may be identified as a period followed by a command. Additionally, parameters relating to the embedded command may be included along with the command to signal the encryption server how to process the command. For example, a command may indicate the password that should be used to generate the encryption key to encrypt and decrypt the message. At some point in the message the command “.password textpass” may be included in the body of the e-mail. The period followed by text indicates that the following word is a command. In this example the command is “password”. The encryption e-mail server will interpret the command “password” and the word “textpass” following the password command to indicate the password the sender intends to use for the encryption and decryption of the e-mail. Other limitations may be indicated by other commands and associated parameters such as, the number of times the e-mail may be decrypted, or whether the e-mail may be printed, forwarded or copied among others.

The command identifier may be any pre-defined character or combination of characters used to delimit the command. For example, an exclamation point and an asterisk could signify the beginning of a command and an asterisk followed by an exclamation point may signify the end of a command. In the password, example above, the delimited command would be !*password textpass*!. When the sender includes the command in the pre-determined format, the encryption e-mail server is configured to recognize the command and act on the command.

When the sender has included the commands and optionally, the parameters relating to the commands, in the e-mail message, the message is directed to the encryption e-mail server. The sender may address the e-mail to the intended recipient using the conventional a-mail address of the recipient including the recipient's account name, followed by the “at” symbol and the domain suffix of the recipient e-mail server. Once a complete and valid recipient address in indicated, the sender may append a period followed by the Internet domain suffix associated with the encryption e-mail server 205. For example, the intended recipient may be john,doe@recipient.com. If, for example, the encryption server was associated with the domain “jumbleme.com”, the sender would append the jumbleme.com suffix to the recipient e-mail address resulting in the address: john.doe@recipient.com.jumbleme.com.

The sender then sends the e-mail from the sender terminal 207. The message is forwarded over the computer network by the sender e-mail server to the addressee of the e-mail message. In this case, the suffix jumbleme.com indicates to the sender e-mail server to forward to encryption e-mail server associated with the jumbleme.com domain suffix.

The encryption e-mail server then verifies that the sender is a member of the service by analyzing the e-mail header. Specifically, the FROM command in SMTP communication may be used as well as the FROM header in the e-mail message itself. Sender Policy Framework and DomainKeys may be used to further verify the sender is as claimed. The verification and eligibility to send is determined by accessing a list of pre-registered users, stored on the encryption server 205. If registered, the email is processed, encrypted and sent on to the recipient as described hereafter.

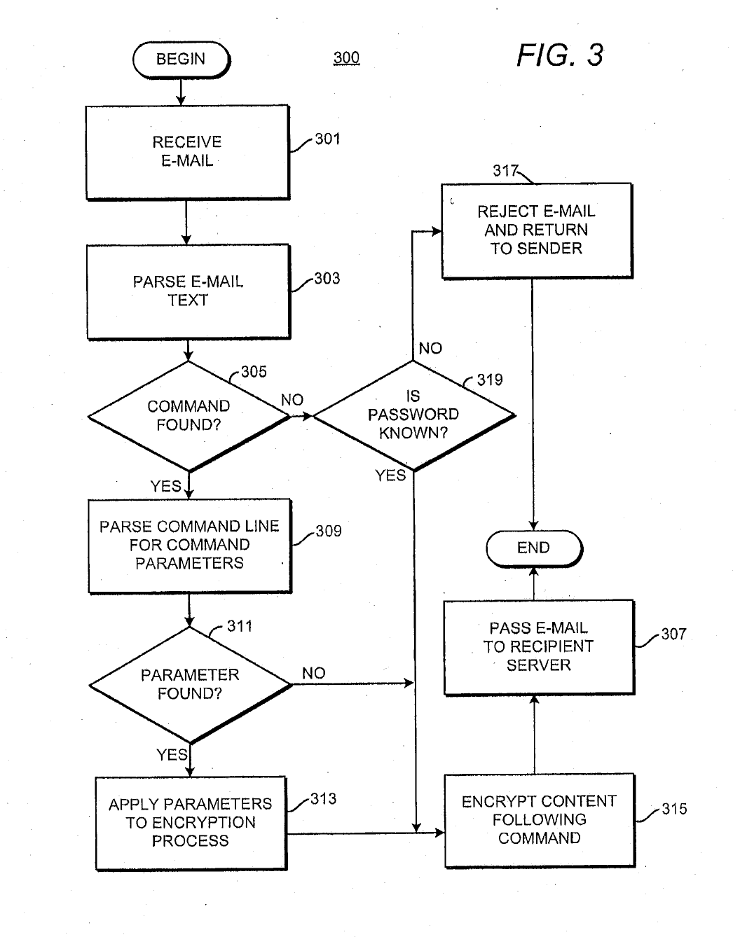

FIG. 3 is a block diagram of an example method of encrypting an e-mail message. Preferably, at least a portion of the process is embodied in one or more software programs which is stored in one or more memories and executed by one or more processors. Although the process is described with reference to the flowchart illustrated in FIG. 3, it will be appreciated that many other methods of performing the acts associated with process may be used. For example, the order of many of the steps may be changed, and some of the steps described may be optional and/or performed manually.

An e-mail is received at the encryption e-mail server from the sender e-mail server 301. The received e-mail may contain an embedded command and/or parameters that may be applied to the command. The received message is addressed to an intended recipient formatted with the recipient's complete email address followed by a period followed by the Internet domain associated with the encryption e-mail server. The encryption e-mail server is configured to receive the e-mail and identify the sender of the message by analyzing the header of the e-mail and SMTP commands used during the delivery of the e-mail as previously described.

The encryption server then parses the body of the received email 303, The encryption server may be configured to scan the text of the e-mail and search for a known command, or alternatively, may be configured to recognize delimiters that contain commands. The encryption server then determines if the body of the e-mail contains a valid command 305.

If the encryption e-mail server does not find a recognized command in the body of the e-mail, the encryption server first checks to see if it already has a password associated with the intended recipient 319. This is determined by keeping a list of previously used passwords for specific recipients that have been used in the past, as well as evaluating if the recipient is already a pre-registered member of the encryption service. If a password is available, the e-mail is encrypted in its entirety 315, and then forwarded to the recipient 307. If no password is available, the e-mail is rejected 317 and returned to the sender, for example in the case of human error.

If the encryption e-mail server parses the e-mail text 303 and finds a recognized command, the encryption e-mail server is configured to parse the command to separate any parameters associated with the recognized command 309. The encryption e-mail server then determines if there are any parameters included with the command 311. If the encryption server determines there is one or more parameters associated with the encrypt command, the encryption e-mail server is configured to apply the parameters while processing the encryption command 313. If the encryption e-mail server does not find parameters associated with the encryption command, the encryption server is configured to encrypt the contents of the e-mail message following the command 315 in a default manner (i.e. without additional parameters). The encryption e-mail server is configured to remove the command from the body of the email once the command is identified and performed. After encrypting the appropriate portion of the e-mail message, the Internet domain associated with the encryption email server is removed from the recipient e-mail address. The remaining recipient address is the original recipient address containing only the recipient user account and domain suffix associated with the recipient e-mail server. The encrypted message is stored by the encryption e-mail server and assigned a unique message identifier.

The encryption e-mail server then forwards an e-mail to the recipient email server using the original recipient e-mail address. The e-mail message passed to the recipient e-mail server 307 is generated by the encryption e-mail server and contains a hyper-text link to the storage location in the encryption e-mail server where the encrypted message is stored, the plain text portion of the email (if any), plus the encrypted contents of the email. When the recipient accesses the e-mail generated by the encryption e-mail server, the recipient is presented with a link that will direct the recipient to the memory location in the encryption e-mail server containing the encrypted e-mail message. Additional software may be used on the client computer to automate this process of reading an encrypted email. Upon connection to the encryption e-mail server, the recipient is prompted to enter a decryption password. When a valid password is entered by the recipient, conditions such as expiration dates are checked, then the email is decrypted and the content displayed to the recipient. The password may be shared previously between the sender and the recipient and stored at the encryption e-mail server. Alternatively, the sender may embed the password as a parameter to the encrypt command and include the parameter and command in the body of the e-mail message. The sender may then inform the recipient of the password in another manner, such as a phone conversation or a letter. As was previously described, portions of the e-mail message preceding the command are not encrypted, so portions of the message may be displayed to the recipient before the message is decrypted. For example, a sender may include the text “This message may be decrypted using the password we discussed earlier” followed by the encrypt command and the password parameter. When the recipient is directed to the encryption e-mail server, and prompted for the decryption password, the text “This message may be decrypted using the password we discussed earlier” will be displayed to the recipient.

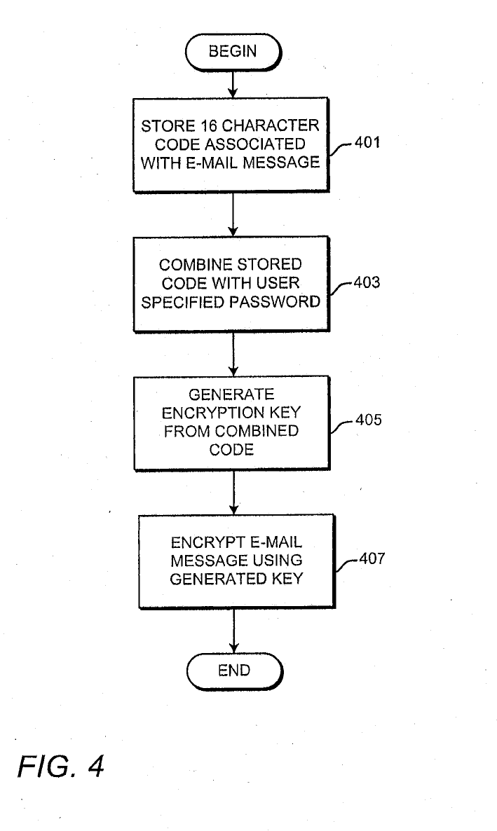

FIG. 4 is a block diagram of an example method of encrypting an e-mail message to limit decryption of the message. Preferably, at least a portion of the process is embodied in one or more software programs which is stored in one or more memories and executed by one or more processors. Although the process is described with reference to the flowchart illustrated in FIG. 4, it will be appreciated that many other methods of performing the acts associated with process may be used. For example, the order of many of the steps may be changed, and some of the steps described may be optional and/or performed manually.

When an e-mail is being encrypted by an encryption e-mail server, a 16 character code associated with the e-mail message is generated and linked to the e-mail message 401. The code length of 16 is provided by way of example and other length codes may be used. The e-mail message is associated with a user specified decryption password that may be pre-determined and stored on the encryption e-mail server, or may be specified in the body of the e-mail message in a method as described hereinbefore. The generated 16 character code is combined with the user specified password to create one long code word 403. The combined code word is then used as input to a hash program to generate an encryption key based on the combined code word 405. The encryption e-mail server then encrypts the e-mail message using the generated encryption key 407. The encryption may be performed using an encryption method known in the art. Once encrypted, the encrypted message may be sent to the recipient by either forwarding the encrypted message itself to the e-mail recipient or alternatively, an e-mail containing a hyper-link to the storage location in the encryption e-mail server where the encrypted e-mail is stored.

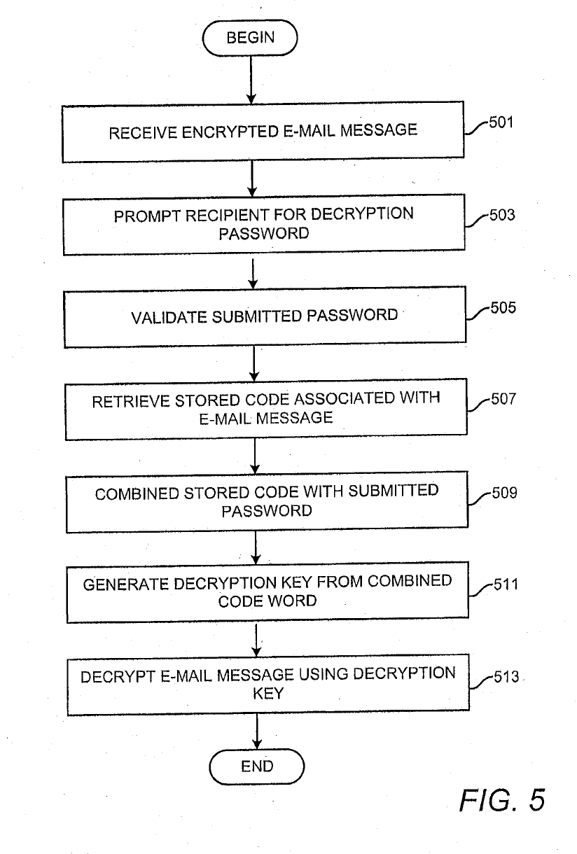

FIG. 5 is a block diagram showing an example of the decryption of an encrypted message that has been encrypted by the method described in FIG. 4. Preferably, at least a portion of the process is embodied in one or more software programs which is stored in one or more memories and executed by one or more processors. Although the process is described with reference to the flowchart illustrated in FIG. 5, it will be appreciated that many other methods of performing the acts associated with process may be used. For example, the order of many of the steps may be changed, and some of the steps described may be optional and/or performed manually.

The e-mail recipient receives an e-mail message 501 containing the encrypted contents of an email message encrypted by the encryption e-mail server. When attempting to read the e-mail message, the recipient is prompted for the user specified password associated with the encrypted e-mail message 503. When the recipient submits the password, an access request is made to the encryption e-mail server. The encryption e-mail server validates the password submitted by the recipient 505. If the password is correct, the encryption e-mail server retrieves the saved code associated with the encrypted e-mail message 507. The encryption e-mail server then combines the saved code and the submitted password to create one long code word 509. The combined code word is then used as input to a hash program to generate a decryption key 511. The generated decryption key is then used to decrypt the e-mail message and display the decrypted contents to the recipient 513.

The access the recipient has to the encrypted content is limited because the stored code associated with the encrypted e-mail message must be accessed from the encryption e-mail server each time the contents are decrypted. This limited access to the decryption key allows the encryption e-mail server to control aspects related to the decryption of the message. For example, the sender may specify the number of times an e-mail message may be read. A read limit may be maintained by the encryption e-mail server and associated with the stored code relating to the e-mail message. When the number of permitted decryptions is performed, the encryption email server may prevent the decryption of the contents by controlling access to the stored code. The sender may wish to impose an expiration date on the encrypted message. If the recipient does not decrypt the message before the expiration date, the encryption e-mail server may prevent access to the stored code, and therefore prevent decryption of the message after the expiration date. The sender may with retract a previously send encrypted message. The encryption e-mail server may be configured to accept a retraction request from the sender and subsequently prevent decryption of the message after the retraction request has been received.

In summary, persons of ordinary skill in the art will readily appreciate that methods and apparatus for encrypting and decrypting email messages have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

1. A method of encrypting an email message, the method comprising:
creating an electronic mail message;
embedding a parameter in a body of the electronic mail message, wherein the parameter indicates information for use in encrypting the electronic mail message;
appending to an e-mail address, a domain suffix associated with an encryption electronic mail server;
sending the electronic mail message with the embedded parameter to the encryption electronic mail server.

2. The method of claim 1, further comprising:
parsing the electronic mail message;
identifying the parameter embedded in the body of the electronic mail message; encrypting the electronic mail message using the parameter;
storing the encrypted electronic mail message;
forwarding a second electronic mail message to a recipient indicated in the first electronic mail message, wherein the second electronic mail message contains a hyperlink to the location where the encrypted electronic mail message is stored; prompting the recipient for a password;
generating a decryption key based on the password;
limiting access to decryption by storing a second key;
decrypting the encrypted electronic mail message using the generated decryption key; and
sending the decrypted contents of the first electronic mail message to the recipient.

3. The method of claim 1 wherein the parameter includes a password.

4. The method of claim 1 wherein the parameter includes a number of times the electronic mail message may be decrypted.

5. The method of claim 1 wherein the parameter includes whether the electronic mail message may be printed.

6. The method of claim 1 wherein the parameter includes an expiration time for the electronic mail message.

7. The method of claim 1 wherein the parameter includes whether the electronic mail message may be copied.

8. An electronic device comprising:
a processor; and
associated software configured to:
create an electronic mail message;
embed a parameter in a body of the electronic mail message, wherein the parameter indicates information for use in encrypting the electronic mail message;
append to an e-mail address, a domain suffix associated with an encryption electronic mail server; and
send the electronic mail message with the embedded parameter to the encryption electronic mail server.

9. The device of claim 8, wherein the encryption electronic mail server is configured to:
parse the electronic mail message;
identify the parameter embedded in the body of the electronic mail message; encrypting the electronic mail message using the parameter;
store the encrypted electronic mail message;
forward a second electronic mail message to a recipient indicated in the first electronic mail message, wherein the second electronic mail message contains a hyperlink to the location where the encrypted electronic mail message is stored; prompting the recipient for a password;
generate a decryption key based on the password;
limit access to decryption by storing a second key;
decrypt the encrypted electronic mail message using the generated decryption key; and
send the decrypted contents of the first electronic mail message to the recipient.

10. The device of claim 8 wherein the parameter includes a password.

11. The device of claim 8 wherein the parameter includes a number of times the electronic mail message may be decrypted.

12. The device of claim 8 wherein the parameter includes whether the electronic mail message may be printed.

13. The device of claim 8 wherein the parameter includes an expiration time for the electronic mail message.

14. The device of claim 8 wherein the parameter includes whether the electronic mail message may be copied.

15. A network element comprising:
a server; and
software configured to:
parse an electronic mail message;
identify a parameter embedded in the body of the electronic mail message; encrypt the electronic mail message using the parameter;
store the encrypted electronic mail message;
forward a second electronic mail message to a recipient indicated in the first electronic mail message, wherein the second electronic mail message contains a hyper-link to the location where the encrypted electronic mail message is stored;
prompt the recipient for a password;
generate a decryption key based on the password;
limit access to decryption by storing a second key;
decrypt the encrypted electronic mail message using the generated decryption key; and
send the decrypted contents of the first electronic mail message to the recipient.

16. The network element of claim 15 wherein the parameter includes a password.

17. The network element of claim 15 wherein the parameter includes a number of times the electronic mail message may be decrypted.

18. The network element of claim 15 wherein the parameter includes whether the electronic mail message may be printed.

19. The network element of claim 15 wherein the parameter includes an expiration time for the electronic mail message.

20. The network element of claim 15 wherein the parameter includes whether the electronic mail message may be copied.
